(19) United States
(12) Patent Application Publication
(10) Pub. No.: US 2023/0257097 A1
(43) Pub. Date: Aug. 17, 2023

(54) AIRCRAFT

(71) Applicant: HONDA MOTOR CO., LTD., Tokyo (JP)

(72) Inventor: Manabu Mitani, Wako-shi (JP)

(21) Appl. No.: 18/168,645

(22) Filed: Feb. 14, 2023

(30) Foreign Application Priority Data
Feb. 17, 2022 (JP) 2022-022959

(51) Int. Cl. B64C 1/10; B64D 27/24; B64D 37/04

(52) U.S. Cl. CPC B64C 1/10; B64D 27/24; B64D 37/04

(57) ABSTRACT

An aircraft includes: a bulkhead for partitioning the interior of a fuselage into a front compartment including a cabin in which an occupant rides, and a rear compartment; a battery disposed in the rear compartment and storing electric power for driving an electric motor; and an opening provided in the bulkhead and allowing access to the battery from the front compartment.

### CROSS-REFERENCE TO RELATED APPLICATIONS

This application is based upon and claims the benefit of priority from Japanese Patent Application No. 2022-022959 filed on Feb. 17, 2022, the contents of which are incorporated herein by reference.

### BACKGROUND OF THE INVENTION

### Field of the Invention

The present invention relates to an aircraft that flies using an electric motor.

### Description of the Related Art

U.S. Ser. No. 11/124,308 B2 discloses an aircraft that flies using an electric motor. In this aircraft, a fuel tank and a battery are disposed inside the fuselage. The fuel tank and the battery are arranged in this order from a front side of the fuselage.

### SUMMARY OF THE INVENTION

However, in the aircraft disclosed in U.S. Ser. No. 11/124,308 B2, the battery is disposed rearward of the fuel tank. Therefore, when performing work such as maintenance and replacement of the battery, it is necessary to move the fuel tank to another place to secure a working space. Therefore, there has been a demand for improving the working efficiency.

An object of the present invention is to solve the above-mentioned problem.

According to an aspect of the present invention, there is provided an aircraft that flies using an electric motor, the aircraft comprising: a bulkhead configured to partition an interior of a fuselage into a front compartment including a cabin in which an occupant rides, and a rear compartment; a battery disposed in the rear compartment and configured to store electric power for driving the electric motor; and an opening provided in the bulkhead and configured to allow access to the battery from the front compartment.

According to the above-described aspect, work such as maintenance and replacement of the battery can be performed through the opening from the front compartment including the cabin. In addition, since the work can be performed without providing, in the fuselage, an opening for accessing the battery, it is possible to avoid a decrease in rigidity of the fuselage. As a result, the working efficiency can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic top view of the interior of an aircraft according to an embodiment;

FIG. 2 is a schematic top view of the interior of the aircraft according to a comparative example;

FIG. 3 is a schematic top view of the interior of the aircraft according to a first modification; and

FIG. 4 is a schematic top view of the interior of the aircraft according to a second modification.

### DETAILED DESCRIPTION OF THE INVENTION

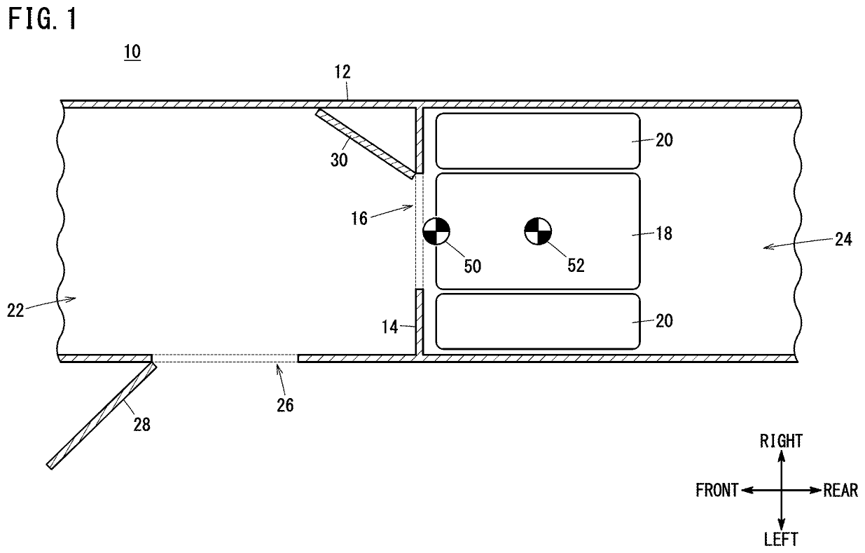

FIG. 1 is a schematic top view of the interior of an aircraft 10 according to an embodiment. In FIG. 1, the front-rear and left-right directions of the aircraft 10 are shown. The aircraft 10 flies using an electric motor. A bulkhead 14, an opening 16, a battery 18, and fuel tanks 20 are disposed inside a fuselage 12 of the aircraft 10. The fuselage 12 refers to the body of the aircraft 10. The fuselage 12 may have a semi-monocoque structure formed of frames, stringers, and a skin (outer skin).

The bulkhead 14 is a wall that partitions the interior of the fuselage 12 into a front compartment 22 and a rear compartment 24. The front compartment 22 includes a cockpit and a cabin. The cockpit is a portion where a pilot controls the aircraft 10, and is disposed forward of the cabin. The cabin is a portion in which occupants ride, and is disposed rearward of the cockpit.

The bulkhead 14 is disposed at one position selected from a plurality of positions where the bulkhead 14 can be arranged in the front-rear direction of the fuselage 12. The bulkhead 14 is selected according to the capacity (size) of the front compartment 22 and the capacity (size) of the rear compartment 24. The capacity of the front compartment 22 is determined according to the maximum number of people who can ride in the front compartment 22. The capacity of the rear compartment 24 is determined according to the amount of space occupied by the items installed in the rear compartment 24. The installed items include a power unit in which the battery 18 and the fuel tanks 20 are provided. The size of the power unit is determined according to the requirements of range, emissions, payload, and the like.

A boarding entrance 26 is provided in the fuselage 12 in the front compartment 22. The boarding entrance 26 may be provided on the right side or the left side of the fuselage 12 in the front compartment 22. FIG. 1 shows an example of a case in which the boarding entrance 26 is provided on the left side of the fuselage 12 in the front compartment 22. The boarding entrance 26 is opened and closed by a door 28. The door 28 is provided on the fuselage 12. The opening and closing directions of the door 28 are not particularly limited. FIG. 1 shows an example of a case in which the door 28 opens in a direction away from the fuselage 12 and closes in a direction toward the fuselage 12.

The opening 16 is a hole for accessing the battery 18 and the fuel tanks 20, and penetrates the bulkhead 14. The opening 16 is opened and closed by an opening/closing door 30. The opening/closing door 30 is provided on the bulkhead 14. The opening and closing directions of the opening/closing door 30 are not particularly limited. FIG. 1 shows an example of a case in which the opening/closing door 30 opens in a direction toward the side surface of the fuselage 12 and closes in a direction away from the side surface of the fuselage 12.

The battery 18 is a power storage device that stores electric power for driving the electric motor and the like. The battery 18 is formed in a shape that can pass through the opening 16. The battery 18 is disposed in the rear compartment 24. The battery 18 is disposed rearward of the opening 16.

The electric motor includes a motor that drives a generator that converts mechanical output into electric output. The electric motor may include at least one of a vertical thrust motor for applying a vertical thrust or a horizontal thrust motor for applying a horizontal thrust. The vertical thrust motor and the horizontal thrust motor are provided at predetermined positions of the aircraft 10 outside the fuselage 12. The vertical thrust motor may be provided in plurality. Further, the horizontal thrust motor may be provided in plurality.

The fuel tanks 20 are containers that store fuel for driving an engine. The fuel tanks 20 are respectively disposed between the battery 18 and the right side of the fuselage 12, and between the battery 18 and the left side of the fuselage 12. In addition, the fuel tanks 20 are disposed adjacent to the battery 18 on the left and right sides of the battery 18.

In a case where a generator is mounted on the aircraft 10, fuel used for power generation by the generator may be stored in at least one of the fuel tank 20 disposed on the right side of the battery 18 or the fuel tank 20 disposed on the left side of the battery 18.

The fuel tank 20 disposed on the right side of the battery 18 and the fuel tank 20 disposed on the left side of the battery 18 may be connected by a support member. The support member may pass through the housing of the battery 18. In this case, the fuel tanks 20 are supported by the battery 18 via the support member. Therefore, even if the fuel tanks 20 become lighter in accordance with a decrease in the fuel due to the flight of the aircraft 10, displacement of the positions of the fuel tanks 20 can be suppressed. Further, the battery 18 may be surrounded by the support member, the bulkhead 14, and the right side and the left side of the fuselage 12. Also in this case, displacement of the positions of the fuel tanks 20 can be suppressed.

The inside of the fuel tank 20 disposed on the right side of the battery 18 and the inside of the fuel tank 20 disposed on the left side of the battery 18 may communicate with each other via a pipe.

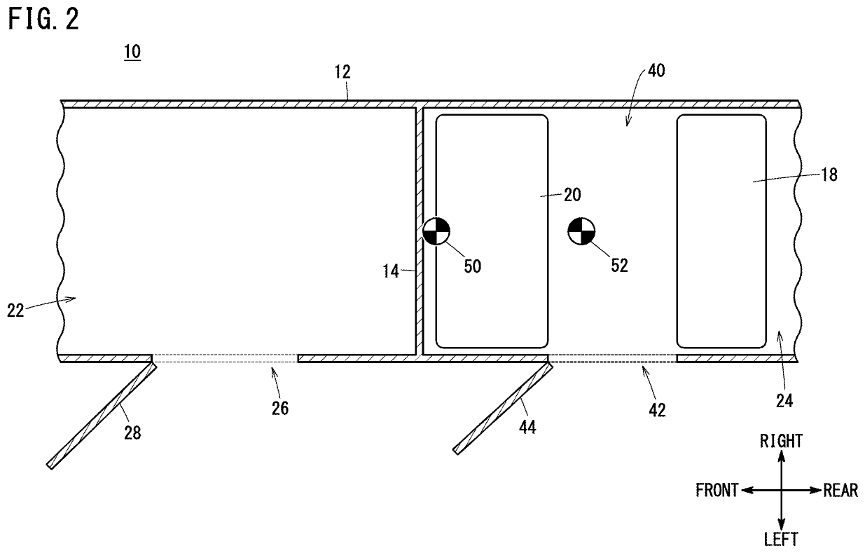

FIG. 2 is a schematic top view of the interior of the aircraft 10 according to a comparative example. In FIG. 2, the same components as those illustrated in FIG. 1 are denoted by the same reference numerals. In the comparative example, the fuel tank 20 is disposed rearward of the bulkhead 14, and the battery 18 is disposed rearward of the fuel tank 20. A working space 40 is provided between the fuel tank 20 and the battery 18. The fuselage 12 is provided with a working entrance 42 and a working door 44 for opening and closing the working entrance 42.

The weight of the battery 18 and the fuel tank 20 occupying the inside of the fuselage 12 is relatively large. Therefore, there is a high possibility that a center of gravity 52 of the aircraft 10 changes depending on the installation positions of the battery 18 and the fuel tank 20. In the comparative example, the battery 18 is disposed rearward of and away from the fuel tank 20. In contrast, in the embodiment, the fuel tanks 20 are disposed on the left and right sides of the battery 18. Therefore, the center of gravity 52 (FIG. 2) according to the comparative example is located farther rearward than the center of gravity 52 (FIG. 1) according to the embodiment. As a result, the distance from an aerodynamic center 50 to the center of gravity 52 is greater in the comparative example than in the embodiment. Therefore, the attitude stability of the aircraft 10 may be affected more in the comparative example than in the embodiment. That is, according to the present embodiment, it is easy to maintain the attitude stability of the fuselage 12.

In a case where the aircraft 10 includes a fixed wing, the aerodynamic center 50 is the center of lift generated by the fixed wing. Further, in a case where the aircraft 10 includes a front wing and a rear wing, the aerodynamic center 50 is the center of lift generated by the front wing and the rear wing.

As described above, in the present embodiment, the bulkhead 14 is provided with the opening 16 for accessing the battery 18 from the front compartment 22, and the battery 18 is provided rearward of the opening 16. As a result, work such as maintenance and replacement of the battery 18 can be performed from the front compartment 22 through the opening 16. Work such as maintenance and replacement of the fuel tanks 20 can also be performed from the front compartment 22 through the opening 16. Further, it is not necessary to provide, on the fuselage 12, an opening (the working entrance 42 (see FIG. 2)) for accessing the battery 18, separately from the boarding entrance 26. Therefore, it is possible to avoid a decrease in the rigidity of the fuselage 12.

The above-described embodiment may be modified as follows.

### (Modification 1)

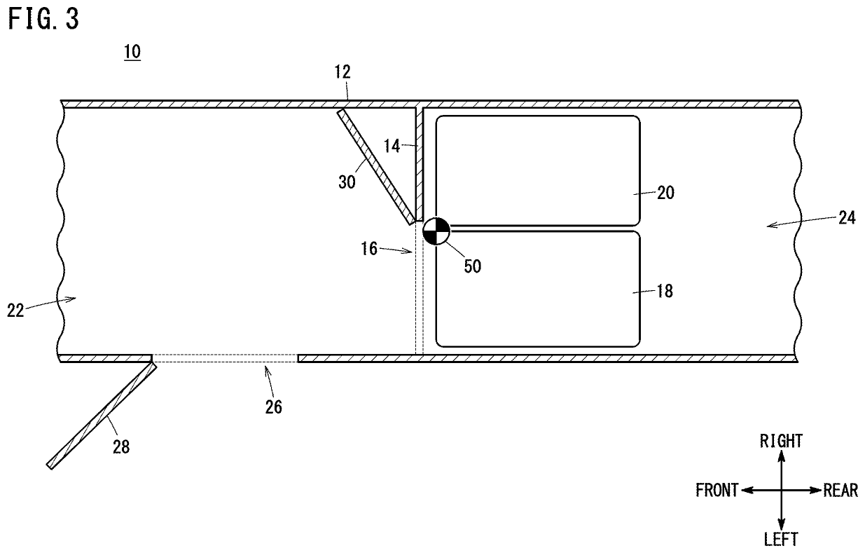

FIG. 3 is a schematic top view of the interior of the aircraft 10 according to a first modification. In this modification, the same components as those illustrated in FIG. 1 are denoted by the same reference numerals. In the present modification, description overlapping with that of the embodiment is omitted.

In the present modification, the opening 16 and the battery 18 are provided near the left side of the fuselage 12 where the boarding entrance 26 is provided. The battery 18 is disposed rearward of the opening 16. The fuel tank 20 is disposed between the battery 18 and the right side of the fuselage 12 where the boarding entrance 26 is not provided.

As a result, as compared with a case where the opening 16 and the battery 18 are provided near the location on the fuselage 12 where the boarding entrance 26 is not provided, the battery 18 can be easily carried in or out through the boarding entrance 26 and the opening 16.

Although FIG. 3 shows an example of a case in which the boarding entrance 26 is provided on the left side of the fuselage 12, the boarding entrance 26 may be provided on the right side of the fuselage 12. In this case, the opening 16 and the battery 18 are provided near the right side of the fuselage 12. Further, the fuel tank 20 is disposed between the battery 18 and the left side of the fuselage 12 where the boarding entrance 26 is not provided.

### (Modification 2)

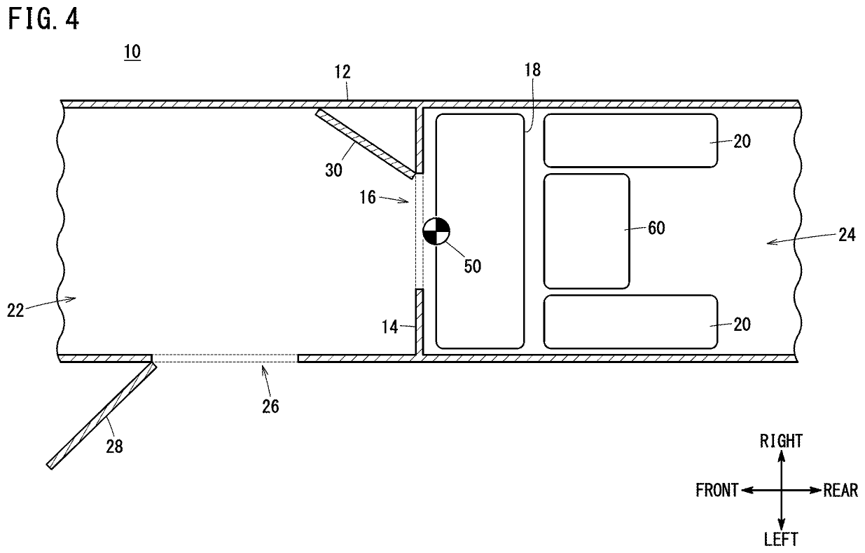

FIG. 4 is a schematic top view of the interior of the aircraft 10 according to a second modification. In this modification, the same components as those illustrated in FIG. 1 are denoted by the same reference numerals. In the present modification, description overlapping with that of the embodiment is omitted.

In the present modification, a control unit 60 is further provided in the rear compartment 24. The control unit 60 is a unit that controls the electric motor and the like. The control unit 60 includes an inverter that drives the electric motor, a boost converter that controls a voltage, a DC converter that steps down a voltage, a rotation control device that controls a rotational speed of the electric motor, and the like.

The control unit 60 is disposed rearward of the battery 18. The fuel tanks 20 are respectively disposed between the control unit 60 and the right side of the fuselage 12, and between the control unit 60 and the left side of the fuselage 12. As a result, as compared with the embodiment in which the fuel tanks 20 are disposed adjacent to the left and right sides of the battery 18, the amount of electric power stored in the battery 18 can be increased.

In the present modification, the battery 18 and the fuel tanks 20 can be disposed closer to the aerodynamic center 50 than in the comparative example. Therefore, the attitude stability of the fuselage 12 can be maintained. In the present modification, an openable/closable maintenance hole for performing maintenance of the fuel tanks 20 may be provided on the outer side of the fuselage 12 in the width direction thereof. As a result, maintenance or the like of the fuel tanks 20 can be performed. The maintenance hole may be provided in the fuselage 12 of the embodiment and the first modification. In a case where the fuselage 12 has a semi-monocoque structure, the maintenance hole may be provided between adjacent stringers or between adjacent frames.

### (Modification 3)

High-voltage components including the battery 18 may be separated from the fuel tank 20 including a pipe. For example, the bulkhead 14 may be provided between the battery 18, and the fuel tank 20 and the pipe. In this case, the battery 18 can be accessed through the opening 16. In order to separate the battery 18 from the fuel tank 20 and the pipe, cases may be provided around the battery 18, and around the fuel tank 20 and the pipe. In this case, the case includes the bulkhead 14 and the opening 16.

The invention and effects that can be grasped from the above description will be described below.

(1) The present invention relates to the aircraft (10) that flies using the electric motor and includes: the bulkhead (14) configured to partition the interior of the fuselage (12) into the front compartment (22) including the cabin in which the occupant rides, and the rear compartment (24); the battery (18) disposed in the rear compartment and configured to store electric power for driving the electric motor; and the opening (16) provided in the bulkhead and configured to allow access to the battery from the front compartment.

According to this feature, work such as maintenance and replacement of the battery can be performed through the opening from the front compartment including the cabin. In addition, since the work can be performed without providing, in the fuselage, an opening for accessing the battery, it is possible to avoid a decrease in rigidity of the fuselage. As a result, the working efficiency can be improved.

(2) In the aircraft according to the present invention, the battery may be disposed rearward of the opening. According to this feature, it is possible to easily perform work such as maintenance and replacement of the battery.

(3) The aircraft according to the present invention may further include the fuel tanks (20) respectively disposed between the battery and the right side of the fuselage, and between the battery and the left side of the fuselage. According to this feature, work such as maintenance and replacement of the fuel tanks can be performed through the opening from the front compartment including the cabin. Further, the battery and the fuel tanks can be disposed in the vicinity of the aerodynamic center (50), and as a result, the attitude stability of the fuselage can be maintained. Further, since the battery and the fuel tanks are arranged in the left-right direction of the fuselage, it is possible to achieve space saving of the rear compartment.

(4) The aircraft according to the present invention may further include the fuel tank disposed between the battery and one of the right side or the left side of the fuselage, and the boarding entrance (26) may be provided on another one of the right side or the left side of the fuselage. According to this feature, work such as maintenance and replacement of the fuel tank can be performed through the opening from the front compartment including the cabin. In addition, the battery and the fuel tank can be disposed in the vicinity of the aerodynamic center, and as a result, the attitude stability of the fuselage can be maintained. Further, as compared with a case where the opening and the battery are provided near the location on the fuselage where the boarding entrance is not provided, the battery can be easily carried in or out through the boarding entrance and the opening.

(5) The aircraft of the present invention may further include: the control unit (60) disposed rearward of the battery and configured to control the electric motor; and the fuel tanks respectively disposed between the control unit and the right side of the fuselage, and between the control unit and the left side of the fuselage. According to this feature, work such as maintenance and replacement of the fuel tanks can be performed through the opening from the front compartment including the cabin. In addition, the battery and the fuel tanks can be disposed in the vicinity of the aerodynamic center, and as a result, the attitude stability of the fuselage can be maintained. Furthermore, as compared with a case where the fuel tanks are disposed adjacent to the left and right sides of the battery, the amount of electric power stored in the battery can be increased.

The present invention is not limited to the above disclosure, and various modifications are possible without departing from the essence and gist of the present invention.

1. An aircraft that flies using an electric motor, the aircraft comprising:
a bulkhead configured to partition an interior of a fuselage into a front compartment including a cabin in which an occupant rides, and a rear compartment;
a battery disposed in the rear compartment and configured to store electric power for driving the electric motor; and
an opening provided in the bulkhead and configured to allow access to the battery from the front compartment.

2. The aircraft according to claim 1, wherein
the battery is disposed rearward of the opening.

3. The aircraft according to claim 2, further comprising
fuel tanks respectively disposed between the battery and a right side of the fuselage, and between the battery and a left side of the fuselage.

4. The aircraft according to claim 2, further comprising
a fuel tank disposed between the battery and one of a right side or a left side of the fuselage, wherein
a boarding entrance is provided on another one of the right side or the left side of the fuselage.

5. The aircraft according to claim 2, further comprising:
a control unit disposed rearward of the battery and configured to control the electric motor; and
fuel tanks respectively disposed between the control unit and a right side of the fuselage, and between the control unit and a left side of the fuselage.
